(19) United States
(12) Patent Application Publication
(10) Pub. No.: US 2009/0256044 A1
(43) Pub. Date: Oct. 15, 2009

(54) SUSPENSION SYSTEM AND METHOD

(76) Inventors: Steve Miller, Charleston, SC (US); Lee Bailey, Raleigh, NC (US)

Correspondence Address: MOORE & VAN ALLEN PLLC, P.O. BOX 13706, Research Triangle Park, NC, 27709, US

(21) Appl. No.: 12/102,718

(22) Filed: Apr. 14, 2008

(51) Int. Cl. G21F 3/00

(52) U.S. Cl. 248/317

(57) ABSTRACT

The present invention is directed to a system and method for suspending a personal radiation protection device. The system includes a support member and a cable mechanically suspended from the support member. The system also includes a member for counter-balancing the weight of a personal radiation protection device. The counter-balancing member is attached to the cable. The system further includes a member for attaching the counter-balancing member to the personal radiation protection device.

### BACKGROUND

This invention relates generally to a suspension system and method, and more particularly to a system and method for suspending medical equipment and instruments in a medical environment.

The practice of medicine can be a physically demanding job, potentially creating health problems for those practicing medicine. For example, a medical operator may expose his body to radiation, which is used to perform many medical diagnostic and therapeutic tests and procedures, such as cardiac catherizations. To minimize this exposure to radiation, operators commonly wear protective garments containing radiation-absorbing materials, generally lead or other metals, which are worn in the fashion of a vest and apron or a full lead jacket which reaches from the shoulder to the knees. These garments are uncomfortable, heavy and place significant stress on the operator's body, especially the spine. This may present a significant logistic and health challenge for medical operators in radiation environments, such as a catherization laboratory. Indeed, the effects of an operator wearing such a heavy protective garment over an extended period of time is known to be associated with diseases of the spine in the neck and back, knee disorders, and other musculoskeletal problems, which can result in disability, medical expenses, and decreased quality of life for the operator.

For the foregoing reasons, there is a need for a suspension system and method for use in a medical environment. In one aspect, the suspension system and method should allow an operator to wear a personal radiation protection garment minimizing the weight on his body, while not substantially limiting his freedom of movement. In another aspect, the suspension system should allow the operator to quickly release the garment from the suspension system so as to allow an operator wearing the garment to move free of the suspension system.

### SUMMARY

The present invention is directed to a system for suspending a personal radiation protection device. The system comprises a support member, a cable mechanically suspended from the support member, a member for counter-balancing the weight of a personal radiation protection device, and a member for attaching the counter-balancing member to the personal radiation protection device. The counter-balancing member is attached to the cable.

The present invention is also directed to an apparatus for suspending a personal radiation protection device. The apparatus includes a suspension component and a cable supported by the suspension component. The apparatus also includes a member for counter-balancing the weight of a personal radiation protection device. The counter-balancing member is connected to the cable. The apparatus further includes a connection system connecting the counter-balancing member with the personal radiation protection device.

The present invention is also directed to a system for suspending a personal radiation protection garment in a medical environment including a ceiling. The suspension system includes a support rail adapted to be mounted to a portion of the ceiling. The support rail includes a linear track. The suspension system also includes a trolley operable to move along the linear track. The suspension system further includes a cable mechanically suspended from the trolley. The suspension system yet further includes a member for counter-balancing the weight of a personal radiation protection device, where the counter-balancing member is attached to the cable. The suspension system still further includes a member for attaching the counter-balancing member to a personal radiation protection device.

The present invention is also directed to a method for suspending a personal radiation protection garment. The method includes providing a personal radiation protection garment and providing a system for suspending the personal radiation protection garment. The suspension system includes an overhead support member and a cable mechanically suspended from the support member. The suspension system also includes a member for counter-balancing only the weight of the personal radiation protection garment, where the counter-balancing member is attached to the cable. The suspension system further includes a member for attaching the counter-balancing member to the personal radiation protection garment. The method also includes attaching the personal radiation protection garment to the suspension system.

### BRIEF DESCRIPTION OF THE DRAWINGS

For a more complete understanding of the present invention, reference should now be had to the embodiments shown in the accompanying drawings and described below. In the drawings:

FIG. 1 is a perspective view of a suspension system according to an embodiment of the present invention.

FIG. 2 is a front view of the suspension system as shown in FIG. 1.

FIG. 3 is a side view of the suspension system as shown in FIG. 1.

FIG. 4 is an exploded view of a suspension system according to a second embodiment of the present invention.

FIG. 5 is a perspective view of a hanger and connection system according to an embodiment of the present invention.

FIG. 6A is a front view of a portion of a suspension system according to a third embodiment of the present invention.

FIG. 6B is a front view of a quick-connect system according to an embodiment of the present invention.

FIG. 7 is an exploded view of the quick-connect system as shown in FIG. 7A.

### DESCRIPTION

The suspension system according to the present invention is for use in suspending medical equipment and instruments and may be used with any conventional suspension system such as, for example, the system described by U.S. Patent Application Publication Number US 2007/0138415 by Chet R. Rees filed on Dec. 15, 2006 and entitled “System and Method for Implementing a Suspension System,” the contents of which are hereby incorporated by reference. Accordingly, detailed explanations of the functioning of all of the components and method of such suspension system are deemed unnecessary for understanding of the present invention by one of ordinary skill in the art.

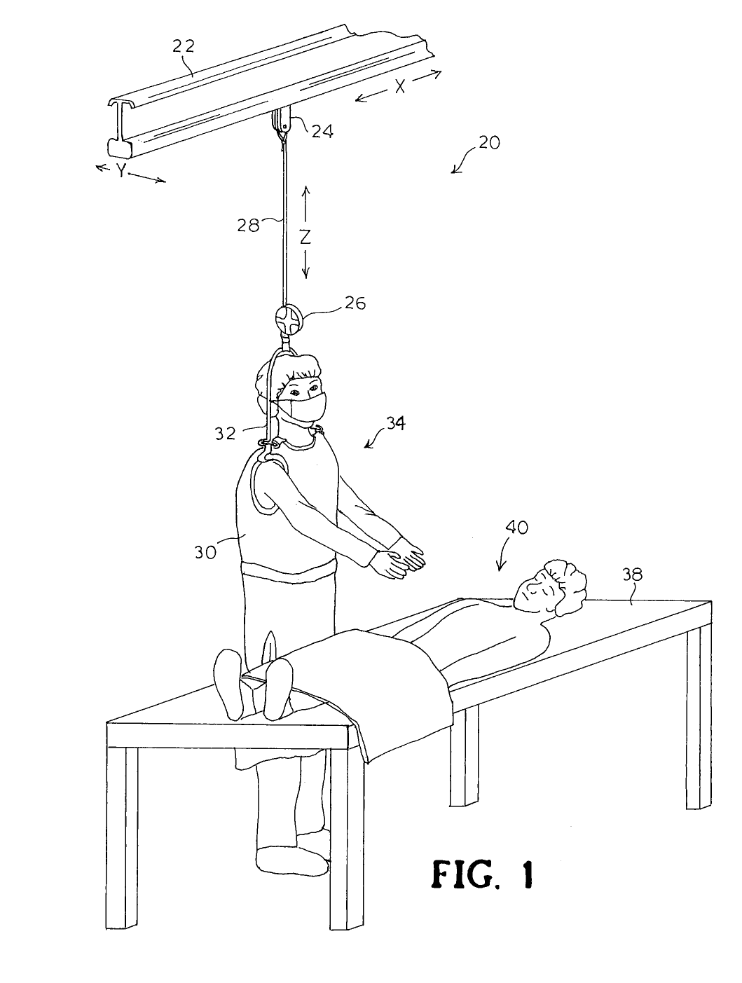

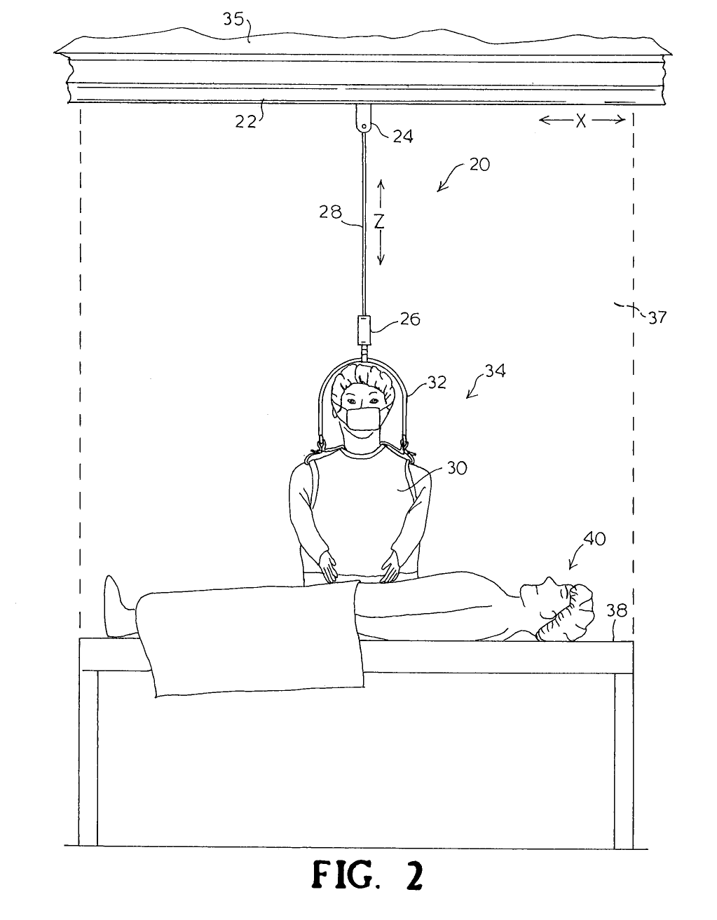

Referring now to the drawings, wherein like reference numbers refer to like elements in each of the several views, FIGS. 1-3 show an embodiment of a suspension system according to an embodiment of the present invention, generally at 20. The suspension system 20 of the present invention includes a rail 22, a trolley 24, a balancer 26 and a cable 28. A personal radiation protection garment 30 worn by an operator 34 is suspended from a hanger 32 which, in turn, is suspended from the suspension system 20. A radiation source (not shown) may be proximate to the operator 34. The radiation source may include any device emitting radiation. For example, in medical procedures, radiation sources may include x-ray machines, nuclear medicine, and devices used for radiation therapy. Other architectures and components of the system 20 may be used without departing from the scope of the present invention.

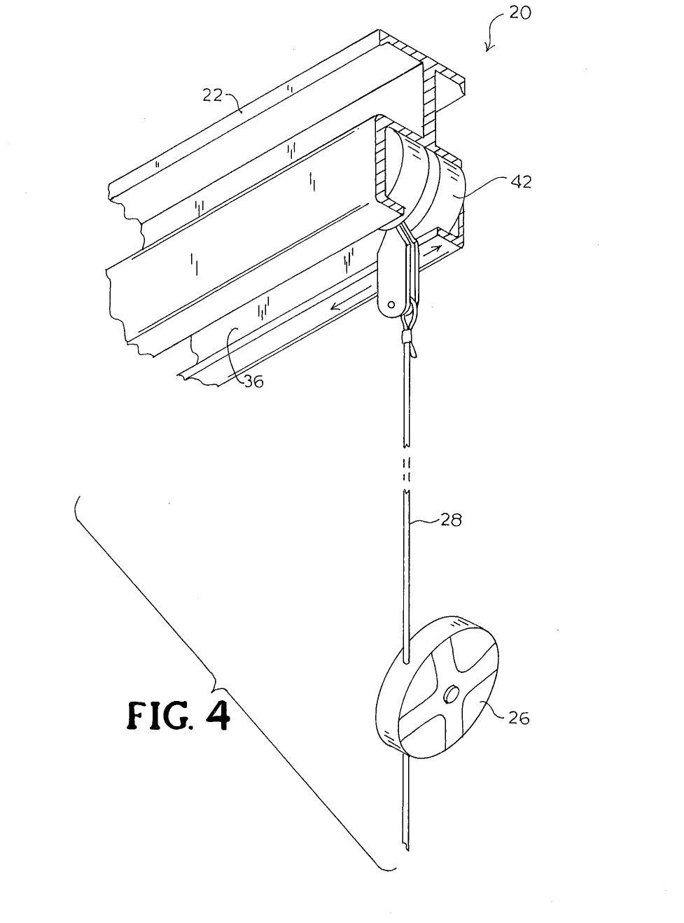

Referring to FIG. 4, a portion of the rail 22 is shown secured to ceiling 35. The rail 22 can be permanently affixed to support structures in the ceiling 35 by any means, such as by bolts, screws and the like. The rail 22 may be made of any suitable material, such as steel or aluminum, which is strong enough to support the weight of the remainder of the suspension system 20 and the suspended personal radiation protection garment 30. The rail 22 can be constructed of one or two I-rails. The rail 22 defines a track 36 on which the trolley 24 slides or rolls. The track 36 may be linear such that the trolley 24 may move only linearly along the axis that the rail 22 is aligned. For example, in FIG. 1, the rail 22 is shown as aligned along the X-axis and the trolley 24 only moves relative to rail 22 along the X-axis. In one embodiment, the rail 22 may have at least one non-linear section (not shown), such as one or more curved sections. In another embodiment, the rail 22 may have an oval or circular shape.

The rail 22 may be affixed to any suitable supporting structure, other than the ceiling 35, including a wall, floor, mobile structure, mobile frame, immobile frame, cable, or any other mechanical means for hanging an item over the head of an operator. While any supporting structure may be employed to mount the rail 22 thereto, the present invention describes and illustrates the rail 22 being affixed to the ceiling 35 as only an exemplary location to mount the rail 22. One skilled in the art would recognize that any other supporting structure may be substituted for the ceiling 35.

Continuing with FIGS. 1-3, the rail 22 may be affixed to the ceiling 35 at any location For example, the rail 22 may be secured to a portion of the ceiling 35 that is directly above a non-operating area, which may be any area that is not directly above an operational surface, such as a medical operation/surgery surface or patient examination surface. In one embodiment, the rail 22 may be aligned along a linear axis that is parallel and adjacent to a prismoidal space 37 above any medical operating or patient examination surface 38 (e.g. a medical bed, an operating table, and the like). The prismoidal space 37 may extend directly above the medical operating surface 38 to a portion of the ceiling 35 corresponding to the medical operating surface 38.

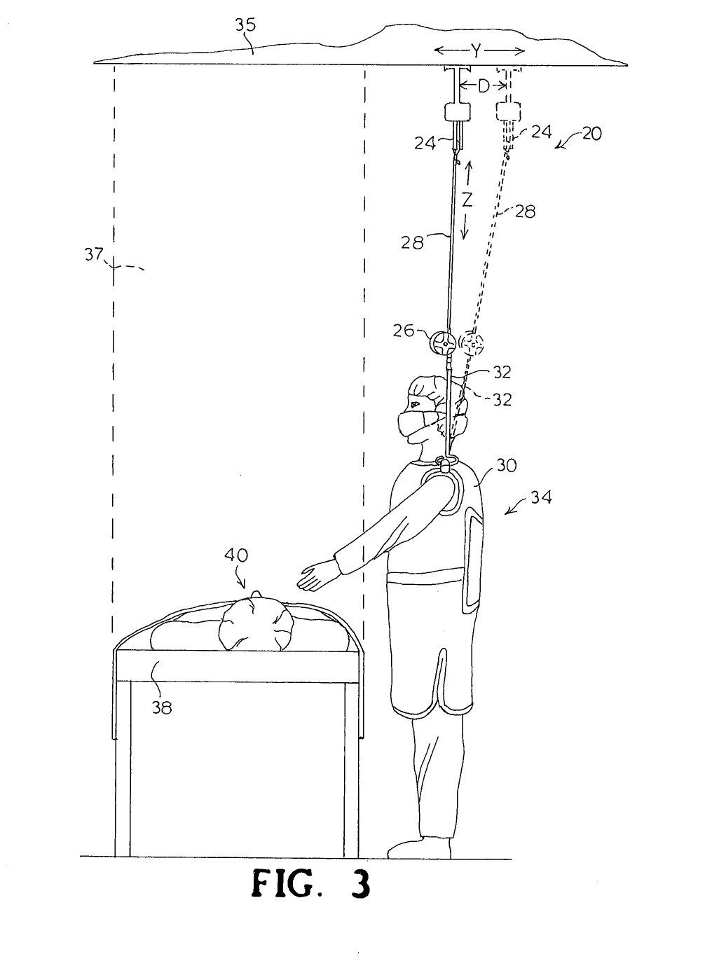

In FIGS. 1-3, the rail 22 is shown as aligned along the X-axis, which is adjacent and parallel to the prismoidal space 37 between a patent's bed 38 and the corresponding ceiling 35 directly thereabove. Referring in particular to FIG. 3, the rail 22 may be placed directly over where the operator 34 stands or a distance D behind the operator 34 when the operator 34 is standing upright and facing his workplace 38 or operating table/bed 38. The rail 22 may run parallel with the operator's table 38, workplace, or medical bed, such that the rail 22 represents the length of the X-axis that the operator 34 can move freely within while utilizing the suspension system 20. Preferably, the rail 22 is not placed directly over the operator's workplace 38 because the operator's workplace 38 should be a sterile or aseptic environment and the rail 22 may contaminate this environment. For example, the rail 22 may not be placed directly over where a patient 40 will be located during radiation treatments/operations.

Referring again to FIG. 4, the trolley 24 can include a roller 42, such that trolley roller 42 is positioned in the runway or linear track 36 of the rail 22. The roller 42 is operable to easily slide or roll along the rail track 36, such that the operator 34 can move freely. The trolley 24 is freely movable along the X-axis of rail 22. The trolley 24 can attach via the cable 28 to the balancer 26, which suspends the personal radiation protection garment 30, such that the operator 34 can only move freely in the X spatial plane defined above by the length of the rail 22. The plane, defined by the X and Z spatial axes, is designed to correspond to the operator's desired work area. The operator 34 wearing the suspended personal radiation protection garment 30 may have a smooth and facile motion within this plane.

Although the operator 34 is allowed free movement along the X-axis, limited movement may be allowed for the operator 34 along the Y-axis. The operator 34 generally moves along the X-axis and thus, most of the operator's movements are confined thereto. However, the operator 34 is still allowed some movement along the Y-axis. For example, the operator 34 is allowed to bend forward or walk forward or backwards to the extent of the extension of the cable 28 attached to the counter balancer.

In another embodiment, the suspension system 20 can include linear motion devices or any other suitable means for allowing the trolley 24 to move freely. For example, linear motion devices are operable for roller bearings to roll inside the guide, such that facile motion is allowed. The trolley 24 can include roller bearings operable to roll inside a guide included in the rail 22, such that facile motion in X-axis is allowed. The suspension system 20 is operable by any suitable means to allow free motion only along in the X axis for the operator 34 wearing the suspended personal radiation protection garment 30.

In one preferred embodiment, the cable 28 may be suspended from the trolley 24 and may attach to the balancer 26. In another embodiment, the cable 28 may be suspended from the balancer 26 and may attach to the hanger 32. In yet another embodiment, the cable 28 may be suspended from the rail 22 and connect to the balancer 26. The cable 28 may be a strap, a rope or a belt. The cable 28 may be several feet long and allows the operator 34 to move extensively in the horizontal X-axis and extensively in the vertical Z-axis. For example, the cable may allow the operator to move six feet end-to-end along the X-axis and four feet along the Z-axis. The cable 28 also allows the operator 34 to move slightly outside the perimeter of the plane formed by the X and Z axes. The cable 28 can include a swivel mount that permits free rotation of the cable suspension mechanism allowing operator 34 to twist as needed. This may include a swivel hook or snap that connects the cable 28 to the balancer 26 or the hanger 32. The cable 28 is operable to safely hold the amount of weight and force caused by the suspended personal radiation protection garment 30.

As described above, the balancer 26 is attached to the trolley 24 by the cable 28. The balancer 26 applies a constant and controllable uplifting force on the garment 30. The spring balancer can include a coiled flat spring, similar to a clock spring, attached to a reel with a conical shape. The cylindrical shape provides a variable mechanical advantage, which offsets the variance of the force provided by the spring as it winds or unwinds, such that there is a relatively constant force on the cable 28 within a definable working range. The tension can be designed to provide optimum relief of the garment's weight for the operator 34, and this force can be constant in all positions of the operator 34. The spring balancer applies a constant force to oppose the weight regardless of how much the cable 28 is extended.

In a preferred embodiment, the balancer 26 can be a zero gravity counter-balancer 26. The counter-balancer 26 may be attached directly to the cable 28 or to the trolley 24. The amount of counterweight may be substantially equal to the weight or load suspended from the counter-balancer 26. When the garment 30 is attached to the counter-balancer 26, the counter-balancer 26 may apply a constant and controllable uplifting force on the garment 30. When the garment 30 is not attached to the counter-balancer 26, the counter-balancer 26 only counter-balances the load, if any, that may be attached to the counter-balancer 26.

The counter-balancer 26 may be a variable counter-balancer 26 such that the amount of weight that the counter-balancer 26 may offset is variable. The variable counter-balancer 26 may be adjusted by hand or remotely such that the user may increase or decrease the amount of weight that the counter-balancer 26 will offset. This may be useful if one or more different types of radiation garments 30 having different weights will be attached to the counter-balancer 26.

The counter-balancer 26 is attached to the cable 28 that hangs from the trolley 24 or rail 22. The cable 28 may be long enough such that the counter-balancer 26 is within an arms-reach of the operator 34 such that the operator 34 may be able to adjust the variable counter-balancer 26 while the operator 34 stands on the floor. However, the counter-balancer 26 may be attached proximate to the rail 22 by connecting directly to the trolley 24 or by connecting to a short cable 28 that is attached to the trolley 24.

In a further embodiment, the balancer 26 may be counterweights. The counterweights apply constant and controllable uplifting force on the garment 30. The counterweights apply the same amount of force to the garment 30 regardless of how much cable may be extended out of the counter-balancer 26. The counterweights allow the operator 34 wearing the suspended personal radiation protection garment 30 freedom of motion in the vertical Z-axis spatial plane.

In yet another embodiment, the balancer 26 can be a constant force spring. The constant force spring applies constant and controllable uplifting force on the garment 30. The constant force spring allows the operator 34 wearing the suspended personal radiation protection garment 30 freedom of motion in the vertical Z-axis spatial plane. The constant force spring applies a constant force to oppose the weight regardless of how much the cable 28 is extended.

In other embodiments, the balancer 26 can include a pneumatic balancer, an air balancer, a spring motor arrangement, an intelligent assist device, or any other system, which provides a counterbalancing function or suspension system 20 for the suspended personal radiation protection garment 30.

In another embodiment of this invention, servomechanisms (not shown) can be used to provide near effortless control and rapid response of the suspension system 20 to bodily motions. The servo mechanics may be incorporated into all axes, or simply into the vertical motion axis alone. The servo apparatus may have motion sensors that detect operator movement, and can stimulate power assisted motion and cessation of motion, minimizing the effort of the operator 34 to move the system, and also minimizing any tendency of the system to move the operator 34 after the operator 34 stops moving. The power motion is achieved by means of motors in conjunction with belts, chains, or cables along the desired axes along the rail 22.

In another embodiment, the balancer 26 may be mounted horizontally along the rail 22 rather than hanging vertically. The balancer 26 mounted horizontally provides more headroom for the operator 34 in a low ceiling 35 or low suspension environment. A pulley (not shown) can be included over the operator's head that can enable the suspension system 20 to create a constant force, such that the operator 34 does not feel the weight of the suspended personal radiation protection garment 30.

A stop (not shown) may also be included in the system. The stop is a device attached to the cable out of the balancer 26 operable to prevent the hanger 32 from going higher than the set level. The stop may engage the balancer 26, such that the stop and the hanger 32 are prevented from moving too high. For example, the operator 34 can remove the suspended personal radiation protection garment 30 as another individual firmly grips the hanger 32, and the hanger 32 could be slowly raised until the stop engages the balancer 26.

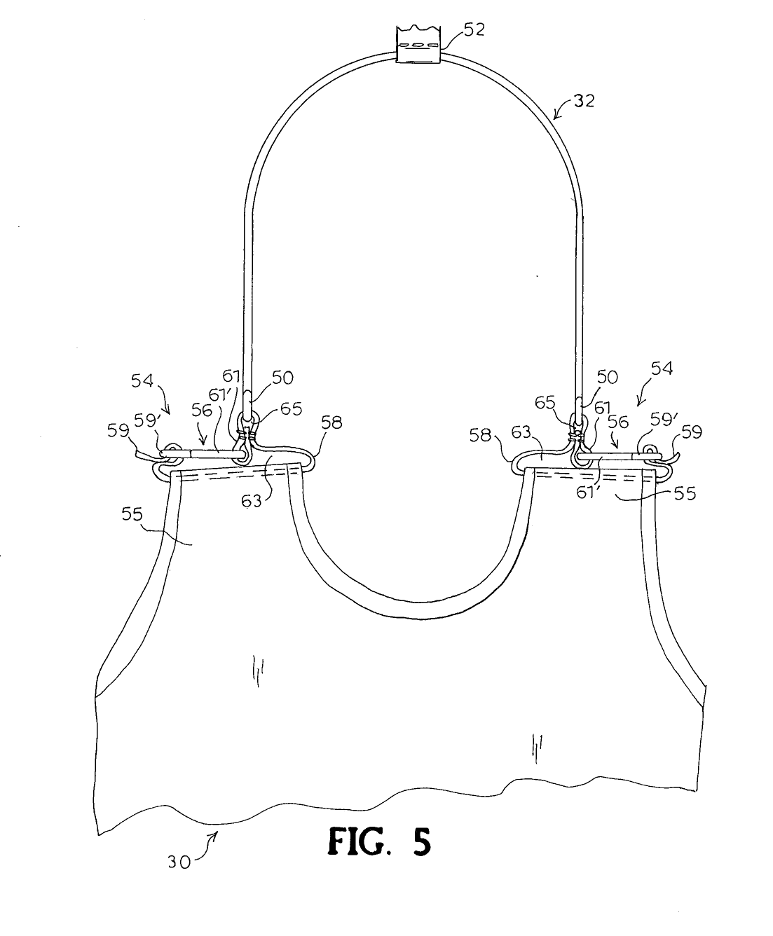

As shown in FIG. 5, the suspension system 20 may further include a hanger 32. The hanger 32 is configured so that it may be connected to an existing personal radiation protection garment 30. The hanger 32 may include a bar 44 bent in a “U” shape, including a curved portion 46 and side portions 48, 48′. Hooks 50 are provided at the end of each end of the side portions 48, 48′. The hanger bar 44 is made of any material that can support at least a minimum weight of the suspended personal radiation protection garment 30. In one aspect, the hanger 32 can be a unified, rigid piece, such that the curved portion 46, side portions 48, 48′ and hooks 50 are integrated.

The curved portion 46 is a portion of the hanger 32 bent into a “U” shape. The curved portion 46 is made of any material that can support at least a minimum weight of the suspended personal radiation protection garment 30. The curved portion 46 is meant to transverse around the top of the operator's head so that the curved portion 46 does not hit the operator's head while in use. The curved portion 46 has a first end and a second end.

The side portions 48, 48′ of the bar 44 are attached to (e.g. as by welding) or integral with (e.g. being one integral piece) the curved portion 46 of the bar 44. Each side portion 48 of the bar 44 is made of any material that can support at least a minimum weight of the suspended personal radiation protection garment 30. Each side portion 48 of the bar 44 can attach to or be integral with the hooks 50 of the hanger 32 in various embodiments. In one embodiment, each side portion 48 of the bar 44 can such that each side portion 48 is aligned toward the shoulder sleeve of the garment 30 close to operator's neck. This particular embodiment is effective at distributing weight and supporting the suspended garment 30.

The hooks 50 of the hanger 32 may be located at the end of the side portions 48, 48′. Each hook may be made of a material that can support at least a minimum weight of the suspended personal radiation protection garment 30. Each hook is positioned over operator's shoulders. The suspended personal radiation protection garment 30 can be placed on the hooks 50, such that the hooks 50 support the weight of the garment 30. In one embodiment, the hooks 50 can be positioned slightly above the operator's shoulders, such that the hooks 50 act as a substitute for the operator's shoulders while the garment 30 is still substantially contoured to the operator's body.

The hanger 32 is operable to suspend the personal radiation protection garment 30. The hanger 32 may be attached to the cable 28, the counter-balancer 26 or a means connecting to the counter-balancer 26. The hanger 32 is sized so as to extend above the operator's head to avoid collision with the operator's head during manipulations. The personal radiation protection garment 30 can be removed from the hanger 32, attached to the hanger 32, and/or remain suspended from the hanger 32 indefinitely. For example, the garment 30 can rest on the hanger 32 similar to a clothes hanger, such that the garment 30 is not resting on the operator's body.

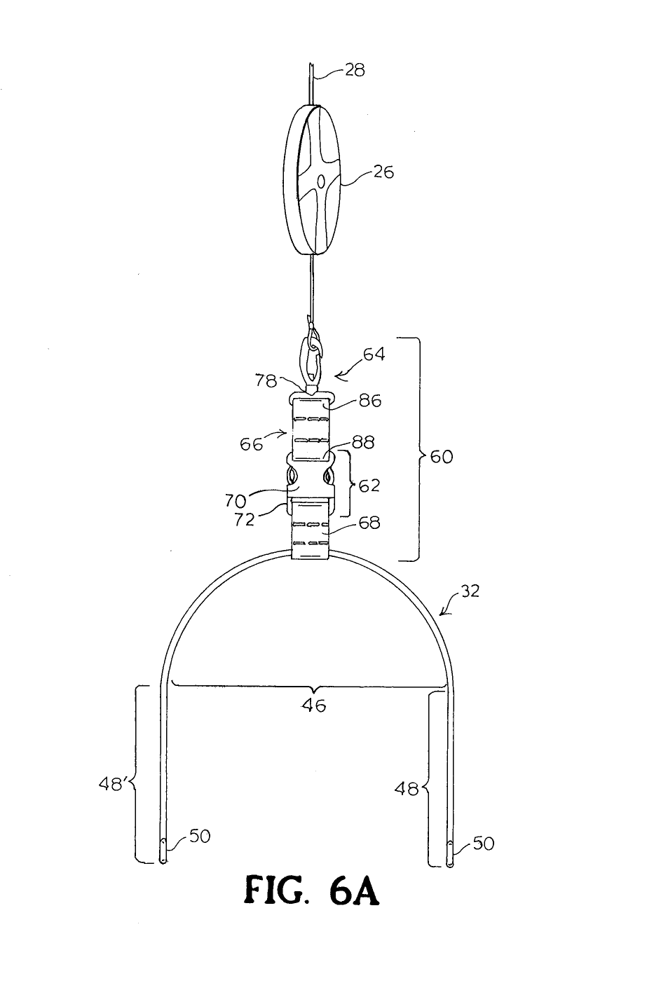

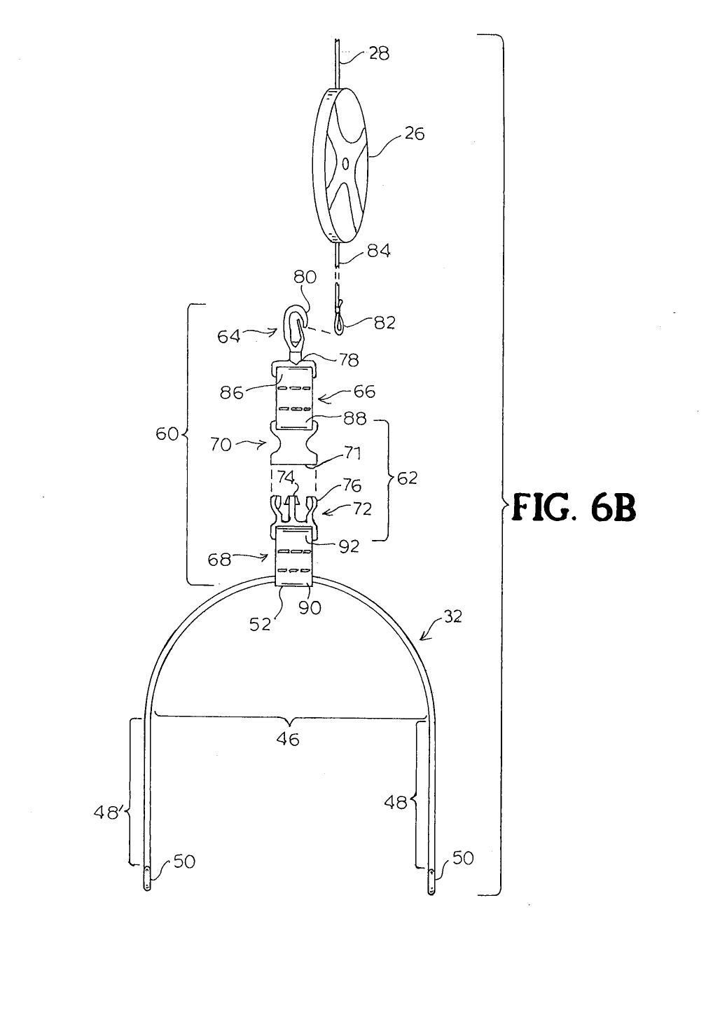

The hanger 32 may have any means to connect the hanger 32 to the balancer 26. The hanger connecting means 52 (FIGS. 6A-B) may be made of any material that can support a minimum weight of the suspended personal radiation protection garment 30. The hanger connecting means 52 may allow the operator 34 to bend sideways, such that the hanger connecting means 52 moves along the hanger 32 to properly distribute weight. The hanger connecting means 52 can be a cable, strap, hook, loop, a pulley, fastener, or any suitable means to attach the hanger 32 to the balancer 26. The hanger connecting means 52 connects the balancer 26 to the bar 44 of the hanger 32. In one embodiment, the hanger connecting means 52 connects to the curved portion 46 of the hanger 32.

As shown in FIGS. 5-6, a connecting system 54 may be provided for connecting the hanger 32 to the garment 30. The connection system 54 is configured so that it may be connected to existing personal radiation protection garments 30. The connecting system 54 may have a buckle 56 and strap 58 and is affixed to each hook 50 of the hanger 32. The connecting system 54 is operable for the hanger 32 to be connected to the garment 30, such that the connecting system 54 attaches the shoulder straps 55 of the garment 30 to the hanger 32.

The strap 58 of the connecting system 54 is made of a web of material that may support at least a minimum weight of the suspended personal radiation protection garment 30. The strap 58 of the connecting system 54 may be any type of flexible strap and made of any flexible material, such as nylon, some other man-made fiber, cotton, or a mixture of cotton. The straps 58 are longitudinally adjustable and depend from the outer edges of the hanger hooks 50. The length of the straps 58 may be adjustable by means of the buckle 56. Each strap 58 may have one end 59 connected to one portion 59′ of the buckle 56 and another end 61 connected to the other portion 61′ of the buckle 56. The strap 58 forms a circle 63 when the two portions of the buckle 56 are attached to each other. The straps 58 are attached to the shoulder region of the garment 30 when on the garment 30. The distance between the straps 58 should be wide enough so that the head of the operator 34 can easily pass through the opening of the garment 30 and be clear of the straps 58. Each strap 58 may be threaded through the head opening and out of the arm opening of the garment 30. The buckles 58 secure the straps 58 in endless loops.

Two adjacent portions of strap 58 may be sewn together to form a small loop 65. The loop 65 is operable to connect to one of the hooks 50 of the hanger 32. The loop 65 is also operable to support at least a minimum weight of the suspended personal radiation protection garment 30. The loop 65 may be located at any portion along the strap 58. The size of the loop 65 is large enough to connect to one of the hooks 50 but is small enough so that the loop 65 is secure within the hook 50. The loop 65 is operable for rotational motion or swivel motion of the loop on the hanger 32. This allows the operator 34 to freely move in forward bending or rearward bending bodily motions. The swivel motion of the loop 65 on the hanger 32 will allow the hanger 32 to maintain a desirable vertical orientation rather than being forced into a tilted angulation, which would apply additional undesirable forces on the hanger 32 and the suspension system 20, as well as place additional downward forces on the cable 28.

A pulley may be attached between the cable 28 and the hanger 32. The pulley is made of material to support weight of suspended personal radiation protection garment 30. The pulley (not shown) is operable to roll along the hanger 32, such that the pulley rolls along the hanger 32 when the operator 34 bends sideways. For example, when the operator 34 bends sideways, the pulley will roll along the hanger 32, such that the hanger 32 becomes tilted. This allows the operator 34 to freely move while the suspended personal radiation protection garment 30 remains properly suspended.

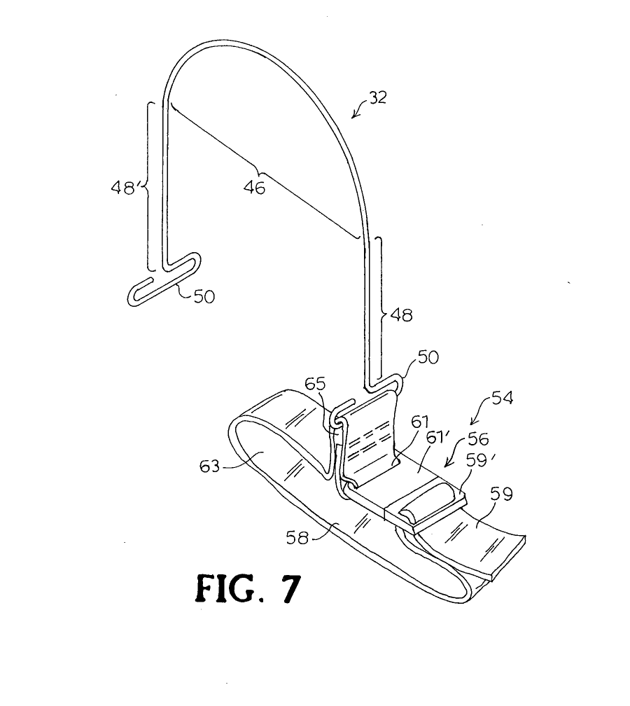

In another embodiment, the hanger 32 may be connected to the balancer 26 via a quick-connect means 60, as shown in FIGS. 7A-B. The quick-connect means 60 includes a buckle 62, clip, a strap 66 connecting the buckle 62 to the clip and a strap 68 connecting the buckle 62 to the hanger 32.

The buckle 62 of the quick-connect means 60 includes a first section 70 and a second section 72. The first buckle section 70 includes a receiving portion 71 and the second buckle section 72 includes an insertion portion 74 so that the second buckle section 72 is operable to removeably connect to the first buckle section 70. The second buckle section 72 may have one or more depressible regions 76 that can quickly and easily be depressed to release the second buckle section 72 from the first buckle section 70. The buckle 62 may be made of material to support weight of suspended personal radiation protection garment 30. Both the first and second buckle sections 70, 72 have sections operable to receive the straps 66, 68.

The clip 64 of the quick-connect system 60 includes a base 78 and a fastening portion 80. The base 78 portion is operable to receive a strap 66. The fastening clip portion 80 is operable to snap onto a loop 82, hook, or a rod. The fastening clip portion 80 may clip onto a portion 84 of the balancer 26 or clip onto a cable 82 or strap that is attached to the balancer 26. The clip 64 is capable of swiveling so as to easily untwist the quick-connect means 60. The clip 64 may be made of material to support weight of suspended personal radiation protection garment 30.

The clip 64 and buckle 62 may be connected via a strap 66. One end 86 of the strap 66 may be attached to the clip 64 and the other strap end 88 is attached to the buckle 62. Each respective end 86, 88 of the strap 66 is doubled back onto itself and sewn so as to be permanently attached.

The buckle 62 may also be attached to the bar 44 of the hanger 32 by another strap 68. The first end 90 of the strap 68 is connected to the bar 44 of the hanger 32 while the other end 92 of the strap 68 is connected to the buckle 62.

The quick-connect system 60 is described above as an exemplary system. It is to be understood that any other quick-connect system may be used to disconnect the hanger or the garment from the suspension system 20. Examples of other quick-connect systems may include Velcro, clips, snap connectors, electronic connecting devices, fasteners, other connectors, and the like.

In accordance with an embodiment of the present invention, an exemplary method of operation is described below. The operator 34 of the present invention may present his personal radiation protection garment 30 to the suspension system 20. The garment 30 may be any garment containing radiation-absorbing material. The garment 30 may be of any shape, size or weight. The garment may be a full length protective garment, an apron, or a garment having any other amount of body coverage.

The hanger 32 may be pre-attached to the garment 30 or to the suspension system 20. To attach the hanger to the garment, the connection system 54 may be employed. As shown in FIG. 6, the shoulder area 55 of the garment 30 connects to the connection system 54 by looping the strap 58 of the connection system 54 around the shoulder areas 55 of the garment 30 and buckling the two ends 61′, 59′ of the buckle 56 together. By doing this, the connection system 54 effectively connects the hanger 32 to the garment 30. The garment may be connected or disconnected from the hanger at any time.

The operator 34 may attach the garment 30 to the suspension system 20 by connecting the hanger 32 that has been pre-attached to the garment 30 to the suspension system 20 or attaching the garment 30 to the hanger 32 that has been pre-attached to the suspension system 20. The hanger 32 may be attached to the suspension system 20 using the quick-connect means 60, previously described with respect to FIG. 7. The quick-connect means 60 acts as a means to quickly attach the garment 30 to the suspension system 20 by connecting the ends 70, 72 of the buckle 62 together. The quick connect means 60 also acts as a means to quickly disconnect the garment 30 by depressing the insertion portion 74 of the buckle so that the ends 70, 72 of the buckle disconnect from each other.

After the garment 30 is suspended from the suspension system 20, the operator 34 may step into the garment 30 by any means to attach the garment 30 to the operator 34. For example, in order to secure the garment 30 to the operator 34, the operator 34 may wrap the garment 30 around the operator's body and secures the garment 30 to itself by Velcro, buckles, or any suitable fastening means for attaching two pieces of a heavy material together. The operator 34 or another individual can strap the garment 30 closed, such that the garment 30 is secured to the operator's body. For example, if the suspended garment 30 has a fastening means on the rear of the garment 30, then the operator 34 can walk up to the suspended garment 30. The operator 34 and/or an assistant can fasten the Velcro or buckles, such that the operator 34 can quickly and effortlessly put on the garment 30 and receive radiation protection. The operator 34 can wear a sterile gown and sterile gloves in the normal manner.

In another embodiment, the operator 34 may be wearing the garment 30 prior to connecting the garment 30 to the suspension system.

Regardless of the load attached to the counter-balancer 26, the line extended from the counter-balancer 26 may remain extended so that the load, such as the garment 30 and hanger 32, only the hanger 32, the extended line, a medical instrument, and the like or any combination thereof, stays at a height where it is positioned by the operator 34. This allows the operator 34 to simply reach out and connect the suspended, extended line of the counter-balancer 26 to the garment 30, or the operator 34 can simply walk into a suspended garment 30 where the operator 34 last positioned it.

At any time, the operator 34 can adjust the weight the counter balancer can support and the distance from the counter-balancer to the rail 22, as appropriate. For example, when the garment 30 is attached to the suspension system 20, the operator 34 can adjust the balancer 26 to the desired counter-balancing weight. This would facilitate the operator 34 of the suspension system 20 to use various personal radiation garments 30 of a different types or weight. Also, the length of the cable 28 may be adjusted so that the counter-balancer 26 is lowered to a particular height with respect to the ceiling 35 or floor.

Additionally, the hanger 32 is designed such that any garment, including custom made garments or existing garments may be easily attached. Because the hanger is adapted to fit onto existing garments, an operator 34 can use his preferred existing garment 30 with this system 20.

When operating with the suspension system, the operator 34 can move freely in the X and Z spatial plane while wearing the suspended personal radiation protection garment 30. The operator 34 can walk diagonally, crouch, or bend sideways in a free motion while receiving protection of the suspended personal radiation protection garment 30.

The operator 34 may have somewhat limited motion in the Y and Z plane to use the radiation device to properly treat the patient 40. The suspended personal radiation protection garment 30 may be substantially weightless to the operator 34, such that the operator 34 is comfortable and unhindered. The operator's arms may be able to freely move in order to properly treat the patient 40. The operator 34 can bend over the patient 40 without causing pain to or asserting extra weight on the operator's spine.

The suspended garment 30 properly protects the operator 34 from harmful radiation. Since the garment 30 is suspended, the garment 30 can be heavier to provide more protection to the operator 34. The suspended garment 30 may be substantially contoured to the operator's body, such that a substantial area of the operator's body is protected. The suspended garment 30 can also be made of thicker material to provide extra protection to the operator 34.

The operator 34 can move freely to return to the spot where the operator 34 initially stepped into the suspended personal radiation protection garment 30. The operator 34 or another individual can quickly and effortlessly unfasten or simply quick-disconnect the garment 30 from the suspension system 20 via the quick-connect means 60 in order to disconnect the garment 30. the garment 30 from the suspension system 20. The operator 34 can easily step out from the suspended garment 30. The garment 30 may remain suspended without the line from the balancer 26 re-coiling any of the extended line, as previously described. For example, the garment 30 can be removed from the suspension system 20 without the balancer 26 recoiling any of the extended line. Alternatively, the hanger 32 can remain hooked to the garment 30 or the counter-balancer 26.

The disconnecting point of the quick-connect means 60 may be at the counter-balancer 26, at the quick-connect means 60, or at the connection system 54 connected to the hooks 50 of the hanger 32. Quick-disconnecting may be useful in emergency situations which occur during operating procedures. For example, it is not uncommon during a procedure in a cardiology catherization lab that a doctor must quickly move to another part of the room that is not covered by the suspension system 20, yet continue wearing the protective garment 30. In this case, the quick-connect means 60 allows him to quickly disengage himself while wearing the protective garment 30 from the suspension system 20, giving him full mobility about the radiation environment, such as having quick access the head or foot of the table, to perform various operations, such as intubating the patient or running a code.

The quick-connect means 60 may swivel. This swiveling capability allows the operator 34 to turn or twist in any direction without the suspension system 20 getting tangled or becoming twisted.

It should be appreciated that while this disclosure discusses hanging one garment 30, any number of garments and/or medical devices, such as any medical tools, devices, and the like, may be suspended from the suspension system. Additionally, any number of suspension systems may be employed to suspend one or more garments for personal radiation protection or to suspend medical tools, devices, and the like.

In accordance with the teachings of the present invention, the suspension system 20 is operable to suspend the garment 30 such that the operator 34 is not hindered or burdened by the weight from the garment 30. The suspension system 20 allows the operator 34 to have complete freedom of motion in the X and Z spatial plane, which is commonly used during medical and research procedures. For example, this allows the operator 34 to move laterally along the side of an operator's table or a medical bed 38. Also, the operator 34 can freely perform vertical motion activities, such as stooping, leaning, squatting, standing on an elevated surface. The tension the balancer 26 asserts on the garment 30 can be designed so as to provide optimum relief of the garment's weight for the operator 34. This force can be constant in all positions by the operator 34.

It is important to note that the stages and steps described above illustrate only some of the possible scenarios that may be executed by, or within, the present system. Some of these stages and/or steps may be deleted or removed where appropriate, or these stages and/or steps may be modified, enhanced, or changed considerably without departing from the scope of the present invention. In addition, a number of these operations have been described as being executed concurrently with, or in parallel to, one or more additional operations. However, the timing of these operations may be altered. The preceding example flows have been offered for purposes of teaching and discussion. Substantial flexibility is provided by the tendered system in that any suitable arrangements, chronologies, configurations, and timing mechanisms may be provided without departing from the broad scope of the present invention. Accordingly, any appropriate structure, component, or device may be included within suspension system 20 to effectuate the tasks and operations of the elements and activities associated with executing compatibility functions.

I claim:

1. A system for suspending a personal radiation protection device, the suspension system comprising:
a support member;
a cable mechanically suspended from the support member;
means for counter-balancing the weight of a personal radiation protection device, the counter-balancing means attached to the cable; and
means for attaching the counter-balancing means to the personal radiation protection device.

2. The system as recited in claim 1, wherein the counter-balancing means comprises a zero gravity balancer.

3. The system as recited in claim 2, wherein the zero gravity balancer is operable to balance weight substantially equal to the weight of the personal radiation protection device.

4. The system as recited in claim 2, wherein the zero gravity balancer comprises variable weight adjustment, wherein the zero gravity balancer is adjustable to balance at least two different weights.

5. The system as recited in claim 1, wherein the counter-balancing means is operable to counter-balance only the weight of the personal radiation protection device.

6. The system as recited in claim 1, wherein the counter-balancing means has a carrying force on the attachment means that is substantially matched to a load that is attached to the counter-balancing means.

7. The system as recited in claim 6, wherein the load comprises the personal radiation protection device.

8. The system as recited in claim 1, wherein the counter-balancing means comprises a spring balancer.

9. The system as recited in claim 1, wherein the counter-balancing means comprises at least one counterweight.

10. The system as recited in claim 1, wherein the counter-balancing means comprises an air balancer.

11. The system as recited in claim 1, wherein the counter-balancing means comprises a pneumatic balancer.

12. The system as recited in claim 1, wherein the counter-balancing means comprises a spring motor.

13. The system as recited in claim 1, wherein the support member comprises a rail having a longitudinal member orientated about a longitudinal axis.

14. The system as recited in claim 13, further comprising a trolley having a means for moving along the longitudinal axis of the rail, wherein the trolley is connected to the cable.

15. The system as recited in claim 13, wherein the rail comprises a means for attaching to the ceiling of a room.

16. The system as recited in claim 1, further comprising a means to removeably connect the counter-balancing means to the attachment means.

17. The system as recited in claim 1, wherein the attachment means comprises:
a first end connected to a first portion of the personal radiation protection device;
a second end connected to a second portion of the personal radiation protection device; and
a member connecting the first end and the second end to the counter-balancing means.

18. The system as recited in claim 1, wherein the attachment means comprises:
a hanger; and
a system for attaching the hanger to the personal radiation protection device, the attachment system comprising:
a buckle having a first member and a second member, the first buckle member being operable to connect to the second buckle member; and
a strap having a first end and a second end;
wherein the first strap end is connected to the first buckle member and the second strap end is connected to the second buckle member; and
wherein the strap is connected to the hanger.

19. An apparatus for suspending a personal radiation protection device, the suspension apparatus comprising:
a suspension component;
a cable supported by the suspension component;
means for counter-balancing the weight of a personal radiation protection device, the counter-balancing means connected to the cable; and
a connection system connecting the counter-balancing means with the personal radiation protection device.

20. The apparatus as recited in claim 19, wherein the connection system comprises:
a buckle connector having a first member and a second member, the first member is attached to the counter-balancing means and the first member being operable to removeably connect with the second member;
a hanger; and
a strap connecting the second member of the buckle connector to the hanger.

21. The apparatus as recited in claim 20, wherein the connection system further comprises:
a clip connector having a clip end and a base, the clip end being connected to the counter-balancing means; and
a second strap connecting the base of the clip connector to the first member of the buckle connector.

22. The apparatus as recited in claim 20, wherein the buckle connector further comprises a means to disconnect the first member with the second member.

23. The apparatus as recited in claim 19, wherein the connection system comprises a quick disconnect system.

24. The apparatus as recited in claim 19, wherein the cable has a first end and a second end and wherein the first end is proximate to the suspension component and wherein the counter-balancing means is located proximate to the second end of the cable.

25. The apparatus as recited in claim 20, wherein the connection system is operable to support the weight of the personal radiation system while the first member is connected with the second member.

26. A system for suspending a personal radiation protection garment in a medical environment including a ceiling, the suspension system comprising:
a support rail adapted to be mounted to a portion of the ceiling and comprising a linear track;
a trolley operable to move along the linear track;
a cable mechanically suspended from the trolley;
means for counter-balancing the weight of a personal radiation protection device, the counter-balancing means attached to the cable; and
means for attaching the counter-balancing means to a personal radiation protection device.

27. The system as recited in claim 26, wherein the location of the portion of the ceiling where the support rail is mounted is directly above an area that is adjacent to a medical operating surface.

28. The system as recited in claim 26, wherein the portion of the ceiling where the support rail is mounted is directly above a location that is not aseptic.

29. The system as recited in claim 26, wherein the support rail further comprises a longitudinal piece aligned along a axis that is parallel to a prismoidal space, the prismoidal space extending from a medical operating surface directly above the medical operating surface and perpendicularly to the ceiling, the axis being aligned adjacent to the prismoidal space.

30. A method for suspending a personal radiation protection garment, the method comprising:
providing a personal radiation protection garment;
providing a system for suspending the personal radiation protection garment, the suspension system comprising:
an overhead support member;
a cable mechanically suspended from the support member;
means for counter-balancing only the weight of the personal radiation protection garment, the counter-balancing means attached to the cable; and
means for attaching the counter-balancing means to the personal radiation protection garment; and
attaching the personal radiation protection garment to the suspension system.

31. The method as recited in claim 30, wherein the attaching the personal radiation protection garment to the suspension system comprises attaching the personal radiation protection garment to the attachment means.

32. The method as recited in claim 30, wherein the attaching the personal radiation protection garment to the suspension system comprises attaching a means that is operable to quick-connect the personal radiation protection garment to the counter-balancing means.

33. The method as recited in claim 32, wherein the attaching the quick-connect means comprises attaching a first member of the quick-connect means with a second member of the quick connect means, the first member being connected to the counter-balancing means and the second member being connected to the attachment means, and the first member being operable to removeably connect with the second member.

34. The method as recited in claim 33, further comprising deattaching the first member with the second member.

35. The method as recited in claim 30, further comprising adjusting the counter-balancing means such that the counter-balancing means may support a pre-defined amount of weight.

36. The method as recited in claim 30, further comprising deattaching the personal radiation protection garment from the suspension system.

37. The method as recited in claim 36, wherein the deattaching the personal radiation protection garment from the suspension system comprises deattaching the personal radiation protection garment from the attachment means.

38. The method as recited in claim 30, wherein the suspension system allows a wearer of the personal radiation protection garment to move freely within a spatial plane, and wherein the garment is substantially weightless to the wearer.

39. The method as recited in claim 30, wherein the suspension system is operable to support only the weight of the personal radiation protection garment.

40. The method as recited in claim 30, wherein the system is mounted to a ceiling.
